(19) United States
(12) Patent Application Publication
(10) Pub. No.: US 2007/0226362 A1
(43) Pub. Date: Sep. 27, 2007

(54) MONITORING REGULAR EXPRESSIONS ON OUT-OF-ORDER STREAMS

(75) Inventors: Theodore JOHNSON, New York, NY (US); Shanmugavelayutham Muthukrishnan, Washington, DC (US); Irina Rozenbaum, Monmouth Junction, NJ (US)

Correspondence Address: AT&T CORP., ROOM 2A207, ONE AT&T WAY, BEDMINSTER, NJ, 07921, US

(73) Assignee: AT&T Corp., New York, NY (US)

(21) Appl. No.: 11/554,264

(22) Filed: Oct. 30, 2006

Related U.S. Application Data
(60) Provisional application No. 60/784,315, filed on Mar. 21, 2006.

(51) Int. Cl. G06F 15/16

(52) U.S. Cl. 709/230

(57) ABSTRACT

A system, method and computer-readable medium provide for regular expression matching over a plurality of packets. The method embodiment comprises, for each data segment in a flow with no predecessor in a stored list of objects generated from traversing a deterministic finite sate automation (DFA) associated with the regular expression: traversing the DFA using the data segment and a list of all non-accepting states; and if the plurality of packets is not declared as matching, then storing, as list of equivalence classes, automaton state pairs having different starting states but an identical ending state. Finally, the method comprises determining whether the flow matches the regular expression.

### BACKGROUND OF THE INVENTION

1. Field of the Invention

The present invention relates to data stream analysis and more specifically a system and method of monitoring regular expressions on out-of-order streams.

2. Introduction

Data Stream Management Systems (DSMSs) process and manage massive streams of data. Databases and data streams also have data quality problems. This may take the form of a duplicate item as is common in practical databases. More characteristically, data streams may be out of order. In data streams, the data normally possesses certain attributes that can be used to define order over the stream elements. For example, the stream of IP packets seen at a router is ordered by time seen and may be loosely ordered based on time sent. However, often, the data is received out of order. For example, if one considers the packets that comprise a flow (or a connection), they may not arrive in sequence at the receiver.

In the past few years, a number of techniques have been developed for processing and mining data streams, including computation of various aggregates on them. Data quality issues such as the ones above present a serious problem for DSMSs because computing even simple aggregates on data streams with data quality problems becomes challenging. For example, computing a simple aggregate like the average size of a packet in a stream now requires one to keep the state of the partial stream seen on the link to identify the duplicate packets. The challenge is further exacerbated when one deals with sophisticated streaming queries and the suite of data quality problems including the out-of-order items, both in terms of the state space that needs to be maintained and the processing per-time that is needed.

What is needed in the art is an improved system and method for analyzing data streams.

### SUMMARY OF THE INVENTION

Additional features and advantages of the invention wilt be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

In data streams, the data normally possesses certain attributes that can be used to define order over the stream elements. However, it is often the case that the data is received out of order, which presents a problem for computing aggregates over such data streams, since dealing with out of order data may require maintaining the state on partial streams.

A particular instance of this problem is regular expression matching on data streams, important in such applications as network traffic identification using application signatures. Some work in this field either simplifies the problem by matching at a single data segment, or reassembles the segment in the correct order before applying the regular expression. Neither approach is satisfactory: valid signatures can span multiple segments, but reassembly is very resource intensive.

The present invention relates to an optimized, efficient algorithm for regular expression matching on streams with out of order data, while maintaining a small state and without complete flow reconstruction. Three versions of the algorithm, sequential, parallel and mixed, are implemented and shown on real network traffic data to be effective in matching regular expressions on IP packet streams.

Embodiments include systems, methods and computer-readable media storing instructions for controlling a computing device to perform certain steps. The method embodiment relates to a method for regular expression matching over a plurality of packets. The method comprises, for each data segment in a flow with no predecessor in a stored list of objects generated from traversing a deterministic finite sate automaton (DFA) associated with the regular expression; traversing the DFA using the data segment and a list of all non-accepting states; and if the plurality of packets is not declared as matching, then storing, as list of equivalence classes, automaton state pairs having different starting states but an identical ending state. Next, the method comprises determining whether the flow matches the regular expression.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIGS. 1(a) and 1(b) illustrate overlaps in received data segments that are transmitted and retransmitted;

FIGS. 2(a) and 2(b) illustrate different structures for an objects associated with received partial flows;

FIG. 3 illustrates a deterministic finite state automata describing a query

FIGS. 4(a) and 4(b) illustrate merging pairs and equivalent classes respectively;

FIG. 5 illustrates results associated with an experiment on a mixed version of the algorithm;

FIGS. 6(a) and 6(b) illustrate convergent rates for equivalence classes; and

FIG. 7 illustrates an example method embodiment of the invention.

### DETAILED DESCRIPTION OF THE INVENTION

Various embodiments of the invention are discussed in detail below. White specific implementations are discussed, it should be understood that this is done for illustration purposes only. A person skilled in the relevant art will recognize that other components and configurations may be used without parting from the spirit and scope of the invention.

The problem addressed herein is a sophisticated query that matches a signature that is regular expression on an out-of-order stream with duplicates. This disclosure presents algorithms that carefully maintain a limited number of states to perform the task efficiently in streaming speeds. The motivating problem is as follows.

Before providing more detailed information about the various aspects of the invention, the disclosure first provides some more general introduction of the concepts discussed later. Network monitoring applications, such as Gigascope by AT&T Corp., enable very fine grade application monitoring for finding and identifying strings within the payload of a session. A session may be when a person types in a URL in a web browser or looking up something on Google.com. The desired string to be analyzed and searched might be in the URL, the search, the response, and so forth. The monitoring application may also try to find hidden peer-to-peer traffic in a data stream. Such traffic does not always pass through regular ports. Often such traffics is transmitted on port 80 which is normally used for web traffic, specifically to get around any kind of port blocking. So the only way that a monitoring system can detect peer-to-peer traffic is by looking for signatures within the string between a computing device and another server.

There are some strings that one can look for in a data stream or other strings that there might be certain fields set at various places. For example, suppose that someone is creating their peer-to-peer (PTP) server and happen to know that network monitoring systems may be looking within the packets for application signatures. The peer-to-peer operator may tweek the system so that it always breaks its strings or sets the packet sizes so that part of the string goes in the first packet and part of the string goes in the second packet. This would prevent the monitoring system from seeing the entire signature within any single packet. The system of the present invention addresses this issue and looks for strings across multiple packets. A challenge is that the internet is lossy and TCP is a reliable protocol such that on the application side the network traffic looks as though there is just a continuous stream of packets of data. But from a network monitoring standpoint, it looks quite different. There might be various arbitrary holes inside the packet stream. So a question arises as to how does one fill in these holes. One approach is to fill up the holes by mimicking the TCP reconstruction protocol. Basically this approach is discussed in the present disclosure. There is also herein a discussion on the motivated problems, examples of application signatures like Gnutella and HTTP.

Below is also discussed some problems with the TCP protocol, such as how there might be duplicates and overlaps or dropped packets and so forth. A network monitoring application may in some sense mimic the processing of the TCP to do the packet reconstruction and put all of these segments in the right place. This process is described herein with the discussion of duplicate handling, predecessor processing and excessive processing. The goal of these approaches is to put all of these clumps of data in the right order. The TCP protocol performs a similar function in a very different way.

In order for a system to actually match one of these strings, it has to run these deterministic finite automata (DFA). DFA are known in the art for finding expressions. Using such DFA is one option for finding these strings or signatures within the application. In order to do so, however, the system has to wait until we have the entire TCP sequence, entire TCP flow laid out and finished. The system may basically buffer it and store it until it is completely there and then run the DFA. The problem in this scenario is that the approach is inefficient because many of these TCP flows can be very large.

In order to address this problem, another approach is proposed to process as such as the system can, but whenever the monitors comes to a gap in the processing, it will stop and accumulate all of the stuff beyond the gap. The system then buffers the data that is beyond what can be processed and when it will fill in the gap then will continue to process. However, that approach can be very space inefficient. A benefit may be gained if the system can summarize these partial flows or segments by summarizing for every starting location within the DFA or to the possible ending locations that the system can reach. FIG. 2 illustrates a picture of DFA and it is a somewhat of a very simple device. There 17 states in this case and the figures shows a way to get from one state to another. One can only travel along the arrows if you are in the state and can see a certain letter. If you are in state 1 and you see G then you can move to state 2, if you see an E, then you can move to state 3 and so forth. If you are in state 3 and you don't see a T, then you fail and you have to go back to state 1.

Now if the system has a partial flow, it doesn't know what the entering state will be. So if one wants to summarize the processing which is done by this partial flow by this part of the string then the system must summarize for every possible state within the DFA. So if the system has a bit of text, it can know that if it was in state 1, it can know where the string was going. If it was in state 2, where it was going to go to and so forth up to state 16. Then at state 17, it is done. This is an introduction to the basic features of the sequential algorithm disclosed below. One of skill in the art will understand how with this description they can represent these partial flows by computing these kind of transitions.

This approach takes advantage of the fact that if one takes a bit of text and starts processing it on through this DFA, very shortly the system ends up with only a few states being unique. For example, in DFA No. 2, if I was to try to start from every state and the first letter is a T, there are only a few T transitions. There is one from state 3 to state 4, one from state 11 to 12, one is from state 13 to 15, and one from state 15-16. So the system very rapidly goes from having to process 16 states for every letter in my partial string to having only to process those four states in every string. There are other letters which reduce this even more and so forth. The benefit of this approach is that the system does not need to keep track of everything, but just keep track of what are called equivalence classes. For example, an equivalence class may represent all the things that can lead to state 4, what other things can lead to state 1 and so forth.

This process relates to what is introduced below as the parallel algorithm. In this case, what happens is instead of processing each state the system processes each equivalence class with the expectation that the number of equivalence classes collapses very rapidly, giving a big improvement in performance while still retaining all the information. This feature represents a basic part of the idea.

There is another way to improve upon this idea which is to notice that the sequential algorithm is very fast given any single state that you need to process. So if one is only considering processing from state 1 and figure out where it goes, the system can process this string very quickly. But if the system is trying to process this string on the set of equivalence classes the processing is a lot slower, there are a lot more stuff that needs to be done, such as things to keep track of and a lot more data structures. The benefit of the parallel algorithm is that the system can rapidly collapse the number of equivalence classes. Therefore, one aspect of the invention is to run the parallel algorithm for just a few steps and the system collapses the number of equivalence classes. For those small number of equivalence classes, the system runs again the fast sequential algorithm. This combination may be referred to as the mixed algorithm. This represents an extension of the parallel algorithm but it results in an order of magnitude improvement of processing speed.

We now turn to the more detailed description of the invention. Consider the IP network monitoring application. The TCP protocol sends the content c₁ . . . cₙ to be transferred from the source IP address to the destination in smaller-sized payload in IP packets. Since it is a reliable transport protocol, data that is lost or corrupted, say cᵢ . . . cⱼ is retransmitted. This involves repacketing cᵢ . . . cⱼ as needed. The set of all packets that is involved in this transfer form a flow. The problem studied is to determine which flow, if any, has content c₁ . . . cₙ that matches a profile. The profile is specified as a regular expression. For example, a profile for identifying the flow that comprises a download from the popular Kazaa service is ˆ(GET|HTTP).*[xX][Kk][Λa][Zz][Λa][Λa]—the content should begin with either GET or HTTP, followed by any series of characters before the appearance of x-kazaa (without regard to the lower/upper case). If the string c₁ . . . cₙ is given altogether, there are well-known methods for matching the regular expression to it that involve walking on the automaton derived from the regular expression, with the string. However, the problem is that the string is provided in small-sized segments from the payload of various packets that comprise the flow. Any given regular expression has to be matched across these segments. Further, the content arrives out of order. Packets that comprise the flow may take different paths through the network and thus may be seen at any router in an order that is different from the one they were put together. Some of the packets may not be seen at the router. Further, if one were to compile the content of the flow online as the packets traverse the link, retransmitted packets have contents that may overlap in different ways with the partial content seen thus far. Now matching the regular expression against c₁ . . . cₙ is a serious challenge.

Analysis of network packet contents such as in the problem above at high speeds is crucial to network security and network monitoring applications. It is often required to match the payload of the packet or a number of packets within a stream with a given set of patterns which characterize different applications, viruses or worms, protocols, etc. For example, it was possible in the past to classify applications based on port numbers, but it has become more and more problematic as applications and protocols have become more sophisticated. Hence, a significant amount of work has been done in the past few years on using signatures to identify different applications. Now the patterns which identify them (such as in the Kazaa example above) often constitute not just an explicit string, but rather a regular expression due to its expressive power and flexibility. Similarly, signatures are also used to identify worms and viruses in intrusion detection systems. Developing these regular expression profiles has its own challenges: a polymorphic worm is hard to characterize since it changes its payload in successive infection attempts. Ideally we would like to use a very elaborate application signature that captures a significant number of details about the application and is able to identify it with high degree of accuracy.

The problem identified above is solved in practice in one of two ways. One approach is to restrict the regular expression and use simple profiles that will match a segment found inside a single packet. This severely limits the applicability of the problem because even simple profiles such as the one above for Kazaa has to be matched across multiple segments. The other approach is to reassemble all the segments of the flow into the content string c₁ . . . cₙ and use the well-known regular expression matching methods. The difficulty here is that the full reassembly of the content is prohibitively resource intensive, and a slow process that is unable to keep up with high-speed streams.

Accordingly, the inventors propose algorithms for regular expression matching over a number of network packets without flow reassembly. The algorithm maintains potential start and end states for each segment in tracing the finite state automaton that represents the regular expression. The states are pruned as needed so the algorithm maintains only a limited memory per flow. There are at least three variations of the algorithm depending on how equivalent states are identified and pruned. Further, experimental study of the algorithms with real data shows that they are effective in matching regular expressions against streams of IP packets in real time.

Regular expressions are a powerful language to describe a set of strings. In standard regular expressions, starting with the alphabet symbols, the inventors compose a set of strings using string concatenation, or (“|”) and Kleene Closure (“*”) which are standard for any substring. It is typical to further enhance the language with a range of characters (“[X-Y]”) or single character wildcards (“?”). In application signatures, the inventors preferably further enhance the language with metacharacters for a variety of tasks such as for changing into hexadecimal or more commonly, to require the string to matching at the beginning (“ˆ”) or anywhere. Those of skill in the art and who have worked with Perl or Emacs or any of the other applications that use regular expressions will understand this use. In what follows, the inventors give a few examples of application signatures that are used in network monitoring applications.

Gnutella:

\hat{ } (GNUTELLA|(GET|HTTP).*(X-Gnutella|(
(Server:|User-Agent:)[\t]*(LimeWire|BearShare|
Gnucleus|Morpheus|XoloX|gtk-gnutella|Mutella|
MyNapster|Qtella|AquaLime|NapShare|Comback|
PHEX|SwapNut|FreeWire|Openext|Toadnode|
Shareaza)))

This regular expression is a signature for Gnutella p2p network protocol, and can be used to detect Gnutella data downloads. It is read as follows:

The first string following the TCP/IP header is GNUTELLA, GET or HTTP. (“|” denotes or relationship).

If the first string is GET or HTTP, it can be followed by one or more arbitrary characters (“.” denotes an arbitrary character, “*” is a quantifier representing zero or more), followed by X-Gnutella. The strings GET or HTTP can also be followed by any number of arbitrary characters, followed by either Server: or User-Agent: headers, followed by a number of TAB symbols, followed by one of the strings from the list LimeWire, BearShare, etc.

Kazaa:
ˆ(GET|HTTP).*[xX]−[Kk] [Aa] [Zz] [Aa] [Aa]

This regular expression is designed to identify Kazaa p2p network downloads. It requires that the data following the TCP/IP header starts with either GET or HTTP, followed by an arbitrary string with X-Kazaa appearing anywhere in it.

Yahoo:

\hat{ } (ymsg|ypns|yhoo).?.?.?.?.?.?.?[1wt].*\
xc0\x80

The regular expression above is used by Snort intrusion detection system to identify Yahoo traffic. It matches any packet payload that starts with ymsg, ypns or yhoo followed by seven or fewer arbitrary characters (‘?’ is a quantifier that represents one or less), then followed by a letter l, w or t and some arbitrary characters of any length, and finally the ASCII letters C0 and 80 in the hexadecimal form.

Counter Strike:
cs.*dl.www.counter-strike.net

This rule is also mentioned in [1] and used to detect packets of an online game ‘Counter Strike’. The expression will match any packet that contains a string cs followed by zero or more arbitrary characters, followed by dl.www.counter-strike.net.

HTTP request:

((OPTIONS|GET|HEAD|POST|PUT|DELETE|TRACE|
CONNECT)[ ]+[ −˜]+[ ]+HTTP/1.[01]([ −˜]+
\r \n)+\r\n)

The regular expression for an HTTP request can be used for extraction of HTTP request headers. It matches any packet payload that starts with the key words OPTIONS, GET, etc., followed by one or more space (‘+’ is a quantifier that represents one or more), followed by one or more printable ASCII characters, followed by one or more spaces, followed by HTTP/1.1 or HTTP/1.0, followed by one or more lines with one or more printable ASCII characters (\r\n signify ‘carriage return’ and ‘line feed’ at the end of a line), and ending with an empty line.

HTTP response:

(HTTP/1.[01][ ]+[0-5][0-1][0-9]([ −˜]+
\r\n)+\r\n)

This regular expression can be used for extraction of HTTP response headers. It matches any packet payload that starts with HTTP/1.1 or HTTP/1.0, followed by one or more spaces, followed by a 3 digit HTTP response code, with the first digit between 0 and 5, the second either 0 or 1, and the third between 0 and 9.

The disclosure next defines the problem of signature matching on TCP traffic streams. A stream corresponding to a single TCP flow consists of a number of individual network packets, each packet containing the protocol header and the data segment. Say the data to be transmitted is c₁, . . . , cₙ. When n exceeds certain packet size limit, the data is split among multiple packets, and each packet is transmitted independently. The stream seen by a router consists of data segments d₁, d₂, . . . , dᵢ, . . . , where each segment dᵢ represents a portion of the original data being transmitted. A segment dᵢ=cₛᵢ . . . cₑᵢ is described by the start offset sᵢ and end offset eᵢ within the original data. The length of segment dᵢ is lᵢ=eᵢ−sᵢ+1. The term dⱼ is defined as the predecessor of dᵢ if sᵢ=eⱼ+1 and dⱼ as the successor of dᵢ. On the receiving end, the received data segments need to be reassembled in the correct order, so that the original message can be reconstructed. Dₘ refers to a reassembled portion of the original data c_{S}_{_{m . . .}} c_{E}_{ₘ}.

Due to the nature of computer networks, there can be a number of anomalies in the way the stream segments arrive at the receiver. For a newly arriving data segment dᵢ, and the reassembled data portion Dₘ, there are the following anomalies.

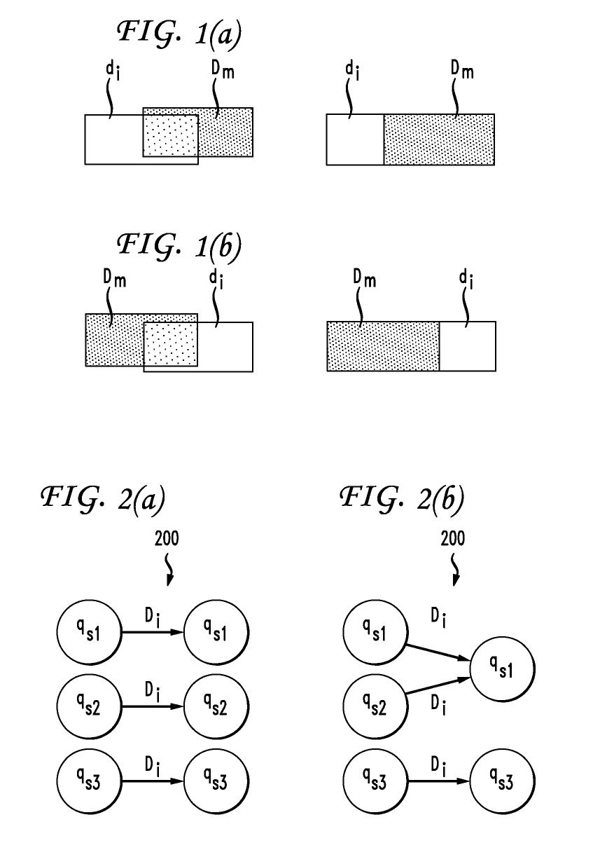

Duplicates and overlaps may exist as shown in FIGS. 1(a) and 1(b). The TCP protocol guarantees reliable information delivery. If receipt of a packet is not acknowledged within a certain period of time, the packet is retransmitted, possibly more than once, until the acknowledgement is received. This can lead to the same data segment being received more than one time on the receiving end. Duplicates can occur in a number of ways:

Case 1: sᵢ≧Sₘ and eᵢ≦Eₘ, i.e. dᵢ is wholly contained in Dₘ.

Case 2: sᵢ≦Sₘ and eᵢ≧Eₘ, i.e. dᵢ is wholly contained in Dₘ.

Case 3: sᵢ<Sₘ and eᵢ≧Sₘ and eᵢ<Eₘ, i.e. start of Dₘ overlaps with the end of dᵢ. FIG. 1(a) illustrates this type of overlap.

Case 4: sᵢ>Sₘ and sᵢ≦Eₘ and eᵢ>Eₘ start of dᵢ overlaps with the end of Dₘ. FIG. 1(b) shows this type of overlap.

Due to various delays in the network communication, packets may arrive out of order, so that for a newly arriving data segment di and the reassembled data portion Dₘ, there can be a case that eᵢ<Sₘ or that sᵢ>Eₘ₊₁.

Given the situation above, a regular expression R and the content c=c₁ . . . cₙ, the problem is to determine if c matched R, given the series of packets dᵢ's.

Next is discussed an overview of preferred embodiments of the invention. Given a string c=c₁ . . . cₙ in-order, the algorithm to apply is described next. The regular expression R is converted into deterministic finite state automata (DFA) and optimized as needed to remove unreachable states. There will be a start state and a set of final states. The algorithm begins at the start state and follows the transitions spelled by the string c and accepted if a final state is realized; else, it is rejected.

In the scenario described above, c is presented as a series of packet segments d₁, d₂, . . . . Matching each dᵢ against R will be incorrect for all R's that span more than one packet of c. Collating all the dᵢ's, resembling them into c and matching R using the basic algorithm above will work. This requires waiting until all data segments of the flow are received, and is therefore slow. Also, it is resource-intensive to reassemble the entire flow c in the network.

A more efficient solution would be to match the regular expression with the reassembled portion of the data received thus far into “partial flows” and wait until a decision (match/no match) is reached. This will be ideal if the partial flow represented a prefix of c. Instead, the fact that some of the data arrives out of order effectively fragments the reassembled data into a number of partial flows Dₘ's. If one wishes not to store the partial substrings that represent arbitrary substrings, he or she needs to simulate the DFA on the Dₘ's, but we do not know the state the DFA will be in after c₁ . . . c_{Sm-1}! Accordingly, a preferred embodiment is to simulate the DFA on Dₘ's with all potential beginning states for Dₘ in the DFA. This will lead to a number of potential end states for each Dₘ. Savings are extruded in this stored “state” by merging partial flows when possible, pruning the potential beginning states for Dₘ and further exploiting the structure of equivalence classes of states reached by simulating the DFA from different begin states.

Equivalence classes can always be merged, its just their nature. E.g. if I have five states, the first equivalence class might be
1→1, (2,3)→3, (4,5)→4
while the second equivalence class is
(1,2,3)→4, 4→5, 5→1
The merged equivalence class (i.e., applying the first, then the second) is
(1,2,3)→4, (4,5)→5
So the issue if not whether then can be merged, it's rather whether they should be merged, and this condition may be to merge equivalent classes of data segments if sequence numbers of the data segments are consecutive.

The algorithm implements the approach above and optimizes the state saved and the execution time. Three example algorithms are discussed: a sequential algorithm, a parallel algorithm that aggressively collapses equivalence states (defined later) and a mixed algorithm that tries to balance the tradeoffs.

The sequential algorithm maintains the information about the received partial flows in the form of a linked list R of objects D₁, D₂, . . . , Dᵢ, . . . , Dₙ. Each Dᵢ=(Sᵢ, Eᵢ, Lᵢ) describes a reassembled partial flow, and contains the following information:
(Sᵢ, Eᵢ) the starting and ending offset of the reassembled data within the original data transmitted within the flow.
Lᵢ—a linked list of pairs (qₛ, qₑ) describing the starting and ending states of paths within the automaton representing the regular expression that can be traversed with the data corresponding to Dᵢ.

FIG. 2 illustrates the structure of the object Dᵢ for (a) the sequential 200 and (b) the parallel 202 version of the algorithm FIG. 2(a) demonstrates 200 a single object Dᵢ of the list R. Each pair of states (qₛ, qₑ) in the list Lᵢ of the object Dᵢ is such that q_{c}=δ(qₛ, Dᵢ).

At various stages of the algorithm, it attempts to find partial flows that either precede or succeed the newly arrived segment in the original data, and merge them into one list entry. If, as a result, two entries Dᵢ and Dᵢ₊₁ are obtained in the list such that Dᵢ precedes Dᵢ₊₁ in the original data, then the algorithm merges them into one entry as well.

As part of the algorithm, the automaton representing the regular expression is traversed with the data contained in the currently processed data segment d, beginning from a given state qᵢ within the automaton. The automaton traversal stops when an accepting state is reached, the end of the data is reached, or when there's no transition on the current data character from the current automaton state.

The return value of the traversal process is a pair of states (qₛ, qₑ), designating the starting and ending states of the path traversed, as well as flags indicating whether the qₛ is the starting state of the automaton, and whether qₑ is an accepting state. The process can also return a null value, signifying that there is no useful path that can be traversed with the given input, which can happen in one of the two cases:
a state is reached during the traversal process from which there is no transition with the next data character
both the beginning and ending state of the traversal process is the starting state of the automaton

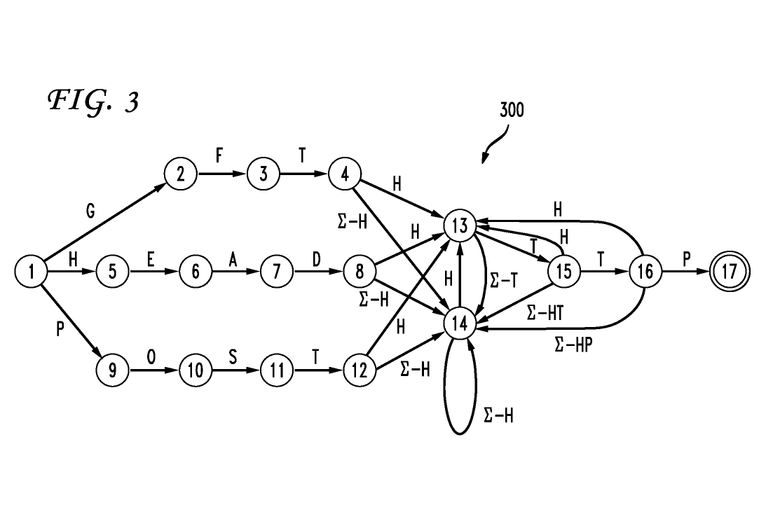

As an example, consider the DFA 300 shown in FIG. 3 for the regular expression ˆ(GET|HEAD|POST).*HTTP. This regular expression is a simplified version of the regular expression for HTTP request message described above:

If the contents of the first packet received is ‘GET’ and this string is run though the automaton starting at state 1, the pair of states that will be recorded is (1, 4). If the next packet of the stream contains ‘HTTP/1.1’ and it is run through the automaton starting from the state (4), the pair of states that will be recorded for this data segment is (4,17). The two pairs are merged resulting into the pair (1, 17) where 1 is the starting state of the automaton and 17 is an accepting state.

Next is discussed the flow start detection. The algorithm begins with R empty. The beginning of a flow is detected by inspecting the value of the SYN bit in the arriving packets, with 1 signifying the flow start. When processing the first packet of the flow, the algorithm distinguishes between two types of regular expressions: those that start with the starting anchor ‘ˆ’ and require the first packet to match starting from the starting state of the automaton, and those that start with ‘.*’ and imply that the regular expression can be matched anywhere within the flow.

Thus the first data segment d₁=(s₁,e₁) of the flow is processed as follows:
Traverse the DFA beginning from the starting state of the automaton.
The regular expression starts with the starting anchor:
   If the traversal process returned null, we label the flow as “not matching”, and no further processing is done on the flow's data.
   If the traversal process returned a pair of states (qₛ, qₑ), with qₛ marked as the starting state of the automaton, create a new entry D₁=(s₁, e₁, L₁) in R, where L₁ contains the pair (qₛ, qₑ), and proceed to the next data segment of the flow.
If the regular expression does not start with the starting anchor:
   If the traversal process returned null, create D₁=(s₁, e₁,<emptylist>) in R
   If the traversal process returned a pair of states (qₛ, qₑ), with qₛ marked as the starting state of the automaton, create a new entry D₁=(s₁, e₁, L₁) in R, where L₁ contains the pair (qₛ, qₑ), and proceed to the next data segment of the flow.

Any other data segment dᵢ=(sᵢ,eᵢ), sᵢ>1, is processed as follows. For each object Dₘ in list R:

Duplicate Handling

If dᵢ is fully contained in Dₘ, ignore dᵢ and proceed to the next segment.
If Dₘ is fully contained in dᵢ, delete Dₘ from R.
If dᵢ and Dₘ partially overlap, chop off the overlapping section of dᵢ by adjusting its (sᵢ, eᵢ) offsets accordingly, as demonstrated in FIGS. 1(a) and (b). Formally, either sᵢ=Eₘ+1 or eᵢ=Sₘ−1 depending on whether Sₘ is smaller than sᵢ or otherwise.
   Predecessor Processing
Say Dₚ=(Sₚ, Eₚ, Lₚ) is a predecessor of dᵢ, i.e. Eₚ=sᵢ−1:
   If Lₚ is not empty, then for each pair (qₛ, qₑ) in Lₚ
      Traverse the automaton with di starting at qₑ.
      If the traversal returns a pair (qₑ, qₑ₁), delete the pair (qₛ, qₑ) from Lₚ, store the pair (qₛ, q_{c1}) in Lₚ and update Eₚ=eᵢ.
      If the traversal returns null, delete (qₛ, q_{c}) from Lₚ. If this renders Lₚ empty, label the current flow as not matching the regular expression, and stop further processing of the flow's data.
   If Lₚ is empty
      Traverse the automaton with dᵢ beginning at the automaton's start state.
      If the traversal returns a pair (qₛ, qₑ), insert the pair (qₛ, qₑ) in Lₚ, and update Eₚ=eᵢ.
      If the traversal returns null, update Eₚ=eᵢ; Lₚ remains empty.
If there is no predecessor for dᵢ in R:
   Create a new entry Dₚ=(Sₚ=sᵢ, Eₚ=eᵢ, Lₚ=<emptylist>) in R.
   Traverse the automaton with dᵢ starting at every non-accepting state, and insert all non-null pairs returned by the traversal process in Lₚ.

At the end of predecessor processing part of the algorithm, dᵢ has been merged in an existing Dₚ, or the algorithm created a new Dₚ for the newly arrived segment. At this stage of the algorithm it checks whether Dₚ has a successor in R.
If a successor Dₛ=(Sₑ, Eₛ, Lₛ), such that Sₛ=Eₚ+1, is found (else, proceed to the next arriving data segment):
   If both Lₚ and Lₛ are non-empty, update Sₛ=Sₚ, merge Lₚ into Lₛ and delete Dₚ from R. The merging procedure is as follows:
      For any pair of states (qₛₚ, q_{cp}) in Lₚ, if q_{cp} is a final accepting state, copy (qₛₚ,qₑₚ)to Lₛ
      For each pair of states (qₛₛ, qₑₛ) in Lₛ, not including those just copied from Lₚ:
         If there is a pair (qₛₚ, qₑₚ) in Lₚ such that qₑₚ=qₛₛ, delete (qₛₛ, qₑₛ) from Lₛ and insert (qₛₚ, qₑₛ)to Ls.
         If no such pair is found, delete (qₛₛ, qₑₛ) from Lₛ.
   If Lₛ is empty, update Sₛ=Sₚ, merge Lₚ into Lₛ and delete Dₚ from R.
   If Lₚ is empty, update Sₛ=Sₚ and delete Dₚ.

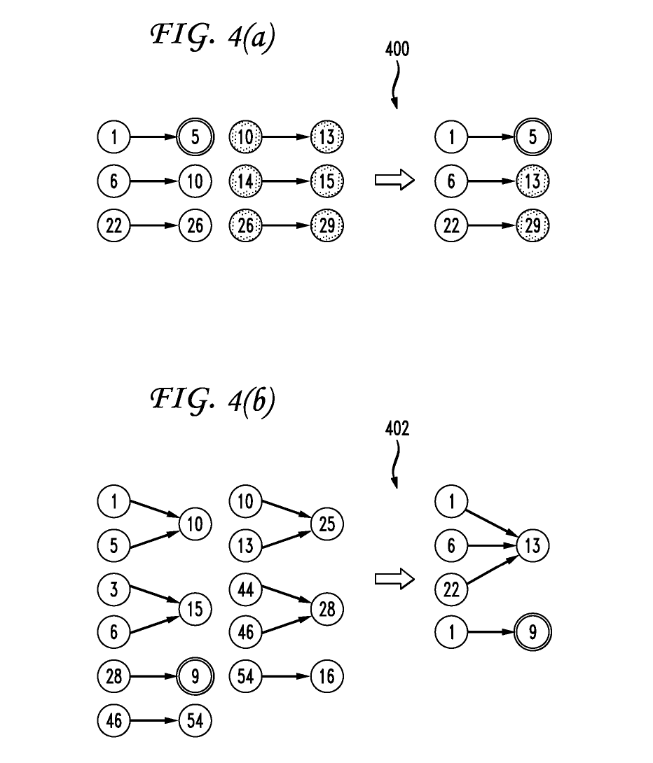

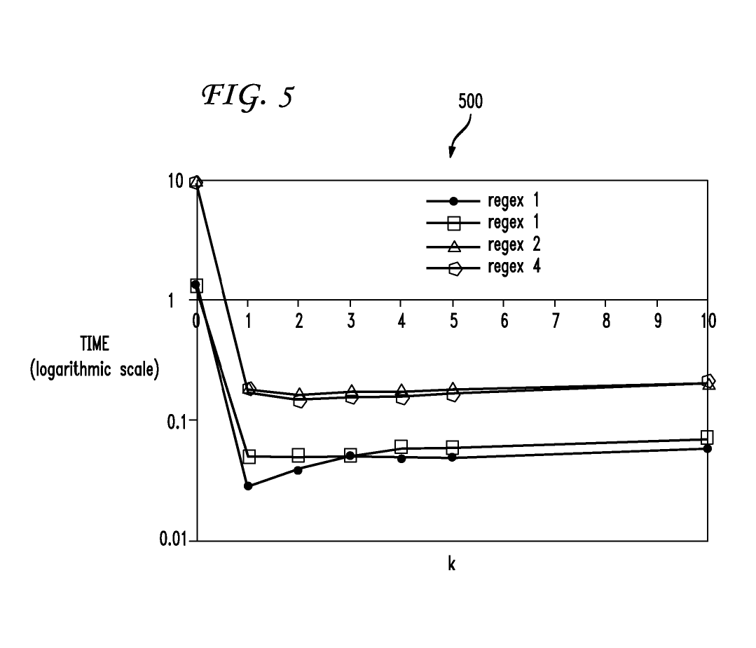

FIG. 4(a) shows an example 400 of the merging procedure outlined above where pairs of states of the predecessor and the successor are merged (sequential version). FIG. 4(b) shows a merging of equivalence classes 402 of the predecessor and successor (parallel version). Match detection is discussed next. At any step of the algorithm, if a pair of states (qₛ, qₑ)such that qₛ is the starting state of the automaton and qₑ is an accepting state is found in any of the L lists, label the flow as matching the regular expression. No additional processing is done on the data from this flow. Table 1 below demonstrates how the algorithm works on a very simple example. As shown in Table 1, using the sequential algorithm to match the regular expression “ˆ(GET|HEAD|POST).*HTTP” (see FIG. 3) to a flow containing the data ‘GET file.html HTTP/1.0’ split into 5 data segments: ‘G’, ‘E’, ‘T’, ‘file.html’, ‘HTTP/1.0’.

TABLE 1

| | | Reassembled | | |
|---|---|---|---|---|
| | Data Segment | Data Segment | Pairs of States in Lᵢ | |
| Packet # | dᵢ = (sᵢ, eᵢ) | Dᵢ = (Sᵢ, Eᵢ) | (qₛ, qₑ) | Notes |
| 1 | ‘G’ = (0, 0) | D₁ = (0, 0) | (1, 2) | first segment |
| 3 | ‘T’ = (2, 2) | D₂ = (2, 2) | (3, 4)(11, 12)(13, 15)(15, 16) | out of order |
| | | | (4, 14)(8, 14)(12, 14)(14, 14)(16, 14) | |
| 4 | ‘file.html’ = (3, 13) | D₁ = (0, 0) | (1, 2)(4, 14)(8, 14)(12, 14) | merge with predecessor |
| | | | (13, 14)(14, 14)(15, 14)(16, 14) | |
| | | D₂ = (3, 13) | (3, 14)(11, 14)(13, 14)(15, 14) | |
| | | | (4, 14)(8, 14)(12, 14)(14, 14)(16, 14) | |
| 2 | ‘E’ = (1, 1) | D₁ = (0, 1) | (1, 3) | merge with predecessor |
| | | D₂ = (0, 13) | (1, 14) | merge with successor. |
| 5 | ‘HTTP/1.0’ = (14, 21) | D₂ = (0, 21) | (1, 17) | match since 1 is the |
| | | | | state of DFA and 17 is |
| | | | | a final accepting state |

Next discussed is the parallel algorithm. In the algorithm description above, if no predecessor is found for the newly arrived data segment, the algorithm traverses the automaton with the segment, starting at each non-accepting state. This can be a performance bottleneck since the automaton can have a large amount of states. In addition, the traversal process can result in a large number of pairs (qₛ, qₑ), and a significant number of those pairs can be duplicates (qₛ₁=qₛ₂ and qₑ₁=qₑ₂) stored in the different lists, or pairs with different starting states but identical ending states (qₛ₁≠qₛ₂ and qₑ₁=qₑ₂).

The inventors focus on the later, and define an equivalence class as a list of automaton state pairs that have different starting states but the identical ending state, and is described as Q=(1ₛ, qₑ), where 1ₛ is a list of starting states (qₛ₁, qₛ₂, . . . , qₛₖ).

The inventors improve the sequential algorithm by storing automaton state equivalence classes instead of state pairs. This would entail several changes as shown below.

Regarding the data structure, each element Dᵢ of the list R maintains the following information:
(Sᵢ, Eᵢ)—the starting and ending offset of the reassembled data within the original data transmitted within the flow.
Lᵢ—the list of equivalence classes, describing the starting and ending states of paths within the automaton representing the regular expression that can be traversed with the data corresponding to Dᵢ.

FIG. 2(b) demonstrates a single object Dᵢ of the list R. Each entry in the list Lᵢ of the object Dᵢ is an equivalence class Q=(1ₛ, qₑ) such that for each qₛ [symbol] 1ₛ, qₑ=δ(qₛ, Dᵢ).

An example process for traversing the DFA is discussed next. Given a list of automaton states and a data segment di containing characters x₁x₂ . . . xₙ, the algorithm will:
1. Attempt to make a transition from each of the states qⱼ with the first character x₁. Store all pairs of states (qⱼ, qₖ), where qₖ=δ(qⱼ, x₁), in a temporary list.
2. Find all pairs in the list with identical end states, delete them from the list and replace them with the corresponding equivalence class. As a result, we obtain a list of equivalence classes Q₁=(lₛ₁, qₑ₁), Q₂=(lₛ₂, qₑ₂), . . . , with |lₛᵢ|≧1.
3. For each Qᵢ, attempt to make a transition δ(qₑᵢ, x₂) unless qₑᵢ is a final accepting state. If such transition exists, update Qᵢ=(lₛᵢ, δ(qₑᵢ, x₂)). Repeat the equivalence class merging procedure described in (2).
4. Repeat steps (3) and (4) until one of the following conditions holds:
   No new transition can be made on the next xᵢ.
   End of the data segment dᵢ is reached. Return the resulting list of equivalence classes.
   An equivalence class Qᵢ is obtained such that one of the states in lₛᵢ is the start state of the automaton, and q_{ci} is a final accepting state. Label the flow as a match of the regular expression, and stop further processing of the flow.

Regarding database segments processing, an example procedure (both dealing with the first segment of the flow and the subsequent segments) is comparable to the sequential version of the algorithm, storing equivalence classes instead of pairs of states. The important difference in the parallel version is in the predecessor handling part of the algorithm, when the segment dᵢ arrives out of order:

Predecessor Processing if there is no predecessor for dᵢ in R:
Create a new entry Dₚ=(Sₚ=sᵢ, Eₚ=eᵢ, Lₚ=<emptylist>) in R
Traverse the automaton using the modified traversal procedure, with dᵢ and the list of all non-accepting states as an input. If the flow is not declared “matching”, store the returned list of equivalence classes in Lₚ.

A similar optimization can be applied for the case when a predecessor is found, but |Lₚ| is large.

Successor processing: Due to the use of equivalence classes instead of pairs of states the merging procedure of two non-empty L lists should be revised when a successor is found. Here is a succinct description of the difference in the algorithm.

At the end of predecessor processing part of the algorithm, the algorithm either merges the newly arrived segment dᵢ in an existing partial flow Dₚ, or creates a new Dₚ based on dᵢ. If a successor Dₛ=(Sₛ, Eₛ, Lₛ), such that Sₛ=Eₚ+1, is found in R, and |Lₚ|>0 and |Lₛ|>0, the algorithm merges the predecessor and the successor into one partial flow by updating Sₛ=Sₚ, merging Lₚ into Lₛ and deleting Dₚ from R. The merge procedure of the L lists works as follows.
For each equivalence class in the successor Qⱼ=(lₛ_{ⱼ}=(qₛⱼ₁, qₛⱼ₂, ), q_{cj}) ε Lₛ, find all predecessor equivalence classes that end at one of the starting states in Qⱼ, that is Qₖ=(lₛₖ, qₑₖ) ε Lₚ such that qₑₖ ε lₛⱼ. Merge such classes into Lₛ: for each such Qₖ, delete qₑₖ from lₛⱼ, and merge lₛₖ to lₛⱼ. Delete Qₖ from Lₚ.
For each Qⱼ in Lₛ, delete all such starting states in lₛⱼ that do not match any of the ending states in any of the predecessor equivalence classes.
If there is a successor equivalence class Qⱼ ε Lₛ and a predecessor equivalence class Qₖ ε Lₚ such that they both end at the same accepting state q_{cj}=q_{ck}, replace the starting list lₛⱼ with the preceding class starting list lₛₖ. Delete Qₖ from Lₚ.
If, after completing all previous steps, there is an equivalence class Qₖ ε Lₚ such that it ends at a final accepting state, copy it to Lₛ and delete it from Lₚ.

FIG. 4(b) shows an example of the merging procedure 402 outlined above, and Table 2 demonstrates how the algorithm works on the example from the previous section. Using the parallel algorithm to match the regular expression “ˆ(GET|HEAD|POST).*HTTP” (see FIG. 3) to a flow containing the data ‘GET file.html HTTP/1.0’ split into 5 data segments: ‘G’, ‘E’, ‘T’, ‘file.html’, ‘HTTP/1.0’.

TABLE 2

| | | Reassembled | | |
|---|---|---|---|---|
| | Data Segment | Data Segment | Equivalence classes in Lᵢ | |
| Packet # | dᵢ = (sᵢ, eᵢ) | Dᵢ = (Sᵢ, Eᵢ) | (lᵢ -qₑᵢ) | Notes |
| 1 | ‘G’ = (0, 0) | D₁ = (0, 0) | (1, 2) | first segment |
| 3 | ‘T’ = (2, 2) | D₂ = (2, 2) | (3, 4)(11, 12)(13, 15)(15, 16) | out of order |
| | | | ((4, 8, 12, 14, 16), 14) | |
| 4 | ‘file.html’ = (3, 13) | D₁ = (0, 0) | (1, 2)((4, 8, 12, 13, 14, 15, 16), 14) | merge with predecessor |
| | | D₂ = (3, 13) | ((3, 4, 8, 11, 12, 13, 14, 15, 16), 14) | |
| 2 | ‘E’ = (1, 1) | D₁ = (0, 1) | (1, 3) | merge with predecessor |
| | | D₂ = (0, 13) | (1, 14) | merge with successor, |
| | | | | delete D₁ |
| 5 | ‘HTTP/1.0’ = (14, 21) | D₂ = (0, 21) | (1, 17) | match since 1 is the |
| | | | | state of DFA and 17 is |
| | | | | an accepting state |

An example mixed version of the algorithms is discussed next. The parallel version of the algorithm significantly reduces the amount of states that needs to be maintained at each step of the algorithm. However, the structure that maintains the states—a list of equivalence class objects—is now more complex, and therefore the overhead of accessing and updating an equivalence class in the list is more significant. To achieve a better tradeoff, a hybrid algorithm is preferred that integrates both the sequential and the parallel versions of the algorithm. The mixed algorithm will still take advantage of the equivalence classes while improving the parallel algorithm's overall performance.
For any out of order data segment di, run the parallel version of the algorithm for k steps, processing k first characters in di and obtaining a list of equivalence classes.
Run the sequential version of the algorithm with the remaining characters in dᵢ, starting from every equivalence class' ending state qₑ.

In this approach, it is assumed that running the parallel version of the algorithm for the first k input characters will yield a limited amount of equivalence classes, thus reducing the amount of states starting from which to apply the sequential version of the algorithm.

Since the algorithm aims at dealing with out of order packets, the inventors in experiments attempted to estimate the significance of this problem on a heavily loaded network. The inventors collected 336 distinct TCP flows and counted the number of various irregularities and fount that 21% of the flows contained out of order packets, 5% of the flows had duplicate packets and 1 flow had an instance of a partial content overlap between two packets. Out of the total of 10, 263 packets observed, the amount of out of order packets constituted 9.7%. This statistics supports the motivation for proposing the algorithm that specifically deals with out of order packets.

The inventors also studied an algorithm versus comparison setup. In order to compare the three algorithm versions, the inventors collected two sets of data sent in TCP packets with either the source or the destination port 80. The first data set consisted of 5,565 data segments, and the second data set consisted of 5,871 data segments.

The study was simplified by supporting only a limited subset of regular expression language, and by simply replacing every occurrence of ‘.*’ with a set of all supported characters.

The implementation was tested on four regular expressions, chosen in part to match some of the data segments in the two data segment sets:

```
    Regex 1:
\hat{ }HTTP/1.[01].*[0-5][0-1][0-9] - match an HTTP
response message.
    Regex 2:
\hat{ } (OPTIONS|GET|HEAD|POST|PUT|DELETE|TRACE|
CONNECT).*HTTP/1.[01] - match an HTTP request
message.
    Regex 3:
HTTP/1.[01].*User-Agent: Mozilla/[45].0 -
match messages generated by Mozilla versions 4.0 or 5.0.
    Regex 4:
HTTP/1.[01]Host: .*google.co.uk - match messages
with the Host header matching google.co.uk.
```

It's important to notice that the last two regular expressions have the implicit ‘.*’ at the beginning. The DFA's built for each of these regular expressions contained 109, 134, 214 and 212 states respectively. Table 3 shows how many data segments from the two data sets matched each of the regular expressions.

TABLE 3

| | Regex 1 | Regex 2 | Regex 3 | Regex 4 |
|---|---|---|---|---|
| Data set 1 | 451 | 454 | 356 | 119 |
| Data set 2 | 317 | 267 | 192 | 33 |

An experiment was conducted to study the out of order DFA traversal time. In this experiment, the inventors compared the running time of the three versions of handling out-of order packets, when trying to match the data in our two data sets with the four regular expressions. For the mixed version, the inventors also ran it with different values of k in order to find the optimal value. The results are presented in Tables 4, 5 and the graph 500 of FIG. 5.

TABLE 4

| | Data set 1 | | | Data set 2 | | |
|---|---|---|---|---|---|---|
| | | | Mix | | | Mix |
| | Seq | Par | k = 1 | Seq | Par | k = 1 |
| Regex 1 | 0.99 | 1.30 | 0.04 | 0.95 | 1.25 | 0.04 |
| Regex 2 | 2.26 | 1.32 | 0.05 | 2.30 | 1.31 | 0.05 |
| Regex 3 | 19.18 | 9.23 | 0.19 | 16.83 | 8.14 | 0.18 |
| Regex 4 | 19.94 | 9.25 | 0.19 | 17.12 | 8.15 | 0.17 |

TABLE 5

| | k | | | | | | |
|---|---|---|---|---|---|---|---|
| | 1 | 2 | 3 | 4 | 5 | 10 | 100 |
| Regex 1 | 0.04 | 0.04 | 0.04 | 0.05 | 0.05 | 0.06 | 0.16 |
| Regex 2 | 0.05 | 0.05 | 0.06 | 0.06 | 0.06 | 0.07 | 0.2 |
| Regex 3 | 0.19 | 0.17 | 0.17 | 0.18 | 0.18 | 0.21 | 1.3 |
| Regex 4 | 0.19 | 0.16 | 0.17 | 0.17 | 0.18 | 0.21 | 1.3 |

Table 4 illustrates out-of-order DFA traversal time (in minutes) and Table 5 shows the out-of-order DFA traversal time, in minutes, of the mixed version of the algorithm for different values of k.

The results demonstrate that the parallel version of the algorithm outperforms the sequential version by more than 50%, and that the mixed version is exceedingly faster than sequential or parallel for any value of k we used, with k=1 yielding the best results for the two regular expressions with the starting anchor, and k=2 or 3 for the two regular expressions starting with ‘.*’.

To investigate the convergence rate of the number of equivalence classes, the inventors needed to maintain on each step of the parallel version of the DFA traversal procedure for an out-of-order packet. The inventors collected this statistic while matching the two data segment sets with each of the four regular expressions. The results obtained were very similar for both data sets, therefore there is no distinction between the data sets in the analysis below.

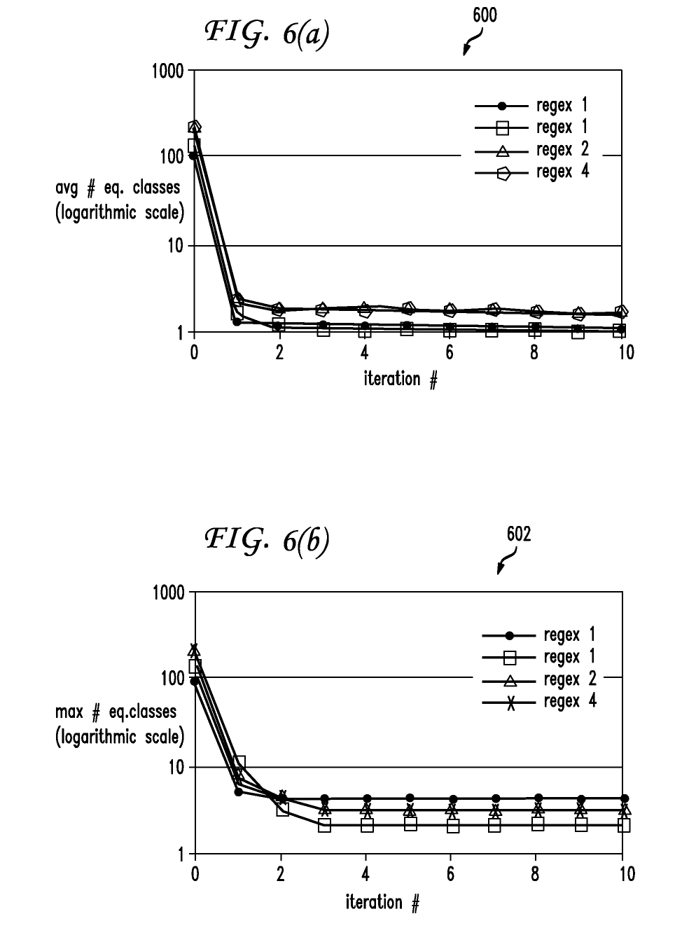

The graph 600 on FIG. 6(a) shows the average number of equivalence classes at every step of the automaton traversal procedure. It can be seen that the number drops from hundreds to one or two, with the convergence rate for regular expressions starting with ‘.*’ being slightly slower. The graph 602 on FIG. 6(b) shows the maximal number of equivalence classes at each iteration. The number drops from hundreds to at most 10 after the first iteration and to at most 4 after the second iteration.

These results confirm the observation from the previous experiment that k=1 yields the best results in the mixed version of the algorithm for regular expressions with the starting anchor, and k=2 or 3 for regular expressions starting with ‘.*’.

One motivation for this work relates to memory requirements and is meant to avoid the need to store the payloads of out-of-order segments. However to do so, one needs to store a summary of the state-to-state transitions after processing a packet. So, the inventors identify a need to quantify this space overhead.

There are at least two options for storing the state-to-state transition summaries. Let S be the number of states in the DFA, and E be the (expected) number of equivalence classes left after processing a packet.
1. Assuming no more than 2¹⁶ DFA states, the system can store an array of S short integers, indicating the ending state for each start state. This approach requires 2 S bytes.
2. Since there are usually very few equivalence classes after processing a packet, one can try a different approach. For each equivalence class, one can record the ending state, and a bitmap of the starting states in the equivalence class. This approach requires E(2+[S/8]) bytes.

Option 2 is preferable to option 1 as long as E<16, which is true for all but the most complex regular expressions. After processing a packet, regex's 1 and 2 had an average of 1.1 equivalence classes, while regex's 3 and 4 had an average of 2.1 equivalence classes. Using 109, 134, 214 and 212 states for the four regex's respectively, memory requirements are obtained of 16, 19, 61, and 61 bytes, respectively. The average packet payload size in out experiments is about 3200 bytes, meaning that algorithm achieves a space reduction of more than 50 to 1 over the naive approach. Actual savings will be considerable higher, as one can use a single summary to represent an out-of-order segment, which consists of several consecutive out-of-order segments.

The present invention addresses the problem of matching a regular expression to a data stream in presence of data quality problems such as duplicates and out-of-order packets. This is a well motivated problem in managing IP networks where regular expressions are signatures that have to matched against the contents of flows to detect intrusions, worms or viruses, applications and protocols. Related work either matched regular expressions against the data segments in individual packets (which misses regular expressions that match across the segments) or reassembled the entire flow to match the regular expression using standard methods (which is highly resource intensive). In fact, in networking, other work has involved solving this problem in specialized hardware. Instead, the inventors have proposed streaming algorithms that can be run in software that match regular expressions across segments even in presence of out-of-order packets and duplicates by carefully optimizing the state maintained on partial flows. The experimental study with real data shows that the algorithms are successful in limiting the memory used and are efficient.

Many regular expressions use “ˆ” operator to force the matching process starting from the beginning of the string. The “$” is an additional operator that enforces the match between the end of the string and the regular expression. However, the inventors have not come across regular expressions applied to streams that use an ending anchor. Support of the ending anchor would require the ability to detect the end of the flow, which is a task that require maintaining a large amount of state. In order for our algorithm to support the “$” operator, techniques similar to that described can to be used, as discussed in T. Johnson, S. Muthuknshnan, V. Snkapenguk, O. Spatschek, “A Heartbeat Mechanism and Its Application in Gigascope,” VLDB Conference, 2005, 1079-1088, incorporated herein by reference.

One embodiment of the invention is a computing claim that performs the steps or algorithms discussed herein. Such computing devices would contain the necessary hardware components such as a processor, memory communication modules, a display, and has to enable its functionality and communication and instruction with other computers. One of skill in the art will understand these basic components to be able to implement such a hardware embodiment. This embodiment may comprise a single computing device or a plurality of computing devices. Furthermore, the “computing device” may comprise multiple computing devices performing the claimed functionality. The functions are typically practical using software modules written in any programming language but may also be implemented in firmware or hardware, which would also be termed a module.

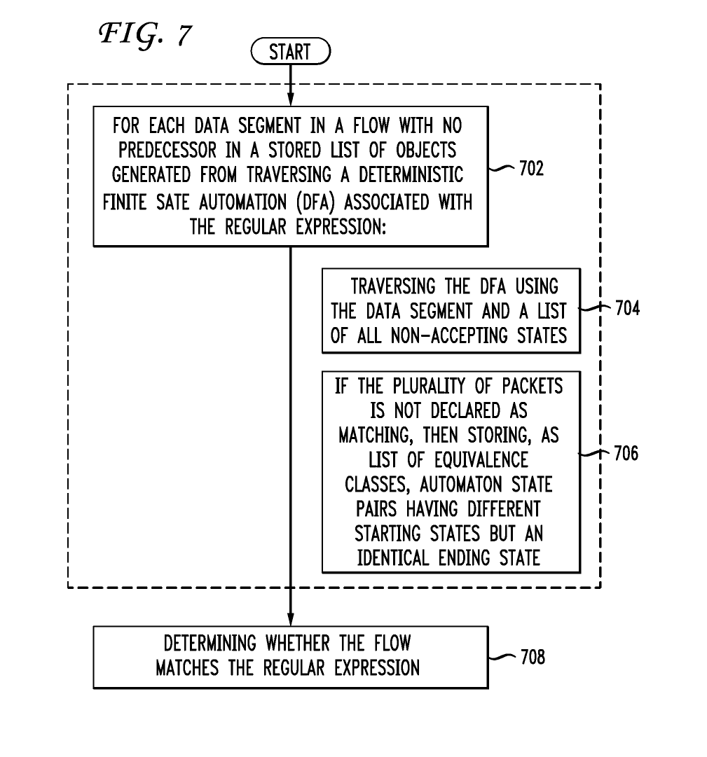

The method embodiment is illustrated by way of example in FIG. 7, which illustrates a method for regular expression matching over a plurality of packets. For each data segment in a flow with no predecessor in a stored list of objects generated from traversing a deterministic finite sate automaton (DFA) associated with the regular expression (702), the system or computing device performs the steps: traversing the DFA using the data segment and a list of all non-accepting states (704), if the plurality of packets is not declared as matching, then storing, as list of equivalence classes, automaton state pairs having different starting states but an identical ending state (706). Next the system determines whether the flow matches the regular expression (708). The first step may only be practiced for a data segment that arrives out of order. Traversing the DFA using the data segment and the list of all non-accepting states may further involve attempting a transition from each state associated with a first character of the data segment, storing all pairs of states identified from the step of attempting in a temporary list, identifying all pairs in the temporary list with identical end states and replacing them with a corresponding equivalence class to generate the list of equivalence classes, for each object in the list of equivalence classes, attempting to make a transition unless a parameter in the attempt is a final accepting state and if such a transition exists, update the respective object in the list of equivalences classes and repeating the steps of attempting, storing and identifying until at least one of the following conditions holds: (a) no new transition can be made on a next parameter in the data segment; (b) an end of the data segment is reached; and (c) an equivalence class is obtained such that one of the states in the class is a start state of the DFA and another state is a final accepting state. As the DFA is traversed, the number of equivalence classes in the list may diminish.

If condition (c) exists above, then the method may provide for labeling the flow as a match of the regular expression. In one aspect of the invention, successor processing comprises, if a successor is found in the list of equivalent classes for the data segment, merging the predecessor and the successor into one partial flow.

The method may involve merging equivalent classes within the list of equivalent classes. In another aspect, if sequence numbers of the data segments are consecutive, then the method involves merging equivalence classes of data segments. Merging the predecessor and the successor into one partial flow may further comprise updating the starting offset of the successor to equal the starting offset of the predecessor and merging the predecessor equivalent class list with the successor equivalent class list and deleting the predecessor object from the equivalent class list.

As the number of equivalent classes reaches a threshold, then the method may comprise applying a sequential algorithm to the diminished number of equivalence classes.

Another aspect of the invention relates to a method for regular expression matching over a plurality of packets, wherein the regular expression is converted into a deterministic finite state automation (DFA). In this aspect, the method comprises, for any out of order data segment, running a first version of a regular expression matching algorithm for a first number of steps, running a second version of the regular expression matching algorithm and determining whether the flow matches the regular expression. Additional steps may include running the second version of the regular expression matching algorithm on remaining characters of the data segment starting from every equivalent class' ending state. The first version of the algorithm may be associated with processing a plurality of equivalence classes and the second version of the algorithm may be a sequential version. In one aspect, the first version of the algorithm stores equivalent classes associated with automaton pairs having different starting states and identical ending states and the sequential version stores state pairs. In another aspect of the invention, a result of running the second version of the algorithm is a listing of state pairs.

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof through a communications network. In a distributed computing environment, program modules may be located in both local and remote memory storage devices.

Although the above description may contain specific details, they should not be construed as limiting the claims in any way. Other configurations of the described embodiments of the invention are part of the scope of this invention. Accordingly, the appended claims and their legal equivalents should only define the invention, rather than any specific examples given.

I claim:

1. A method for regular expression matching over a plurality of packets, the method comprising:
1) for each data segment in a flow with no predecessor in a stored list of objects generated from traversing a deterministic finite sate automation (DFA) associated with the regular expression:
a) traversing the DFA using the data segment and a list of all non-accepting states; and
b) if the plurality of packets is not declared as matching, then storing, as list of equivalence classes, automaton state pairs having different starting states but an identical ending state; and
2) determining whether the flow matches the regular expression.

2. The method of claim 1, wherein step 1) occurs for a data segment that arrives out of order.

3. The method of claim 1, wherein traversing the DFA using the data segment and the list of all non-accepting states further comprises:
attempting a transition from each state associated with a first character of the data segment;
storing all pairs of states identified from the step of attempting in a temporary list;
identifying all pairs in the temporary list with identical end states and replacing them with a corresponding equivalence class to generate the list of equivalence classes;
for each object in the list of equivalence classes, attempting to make a transition unless a parameter in the attempt is a final accepting state and if such a transition exists, update the respective object in the list of equivalences classes; and
repeating the steps of attempting, storing and identifying until at least one of the following conditions holds: (a) no new transition can be made on a next parameter in the data segment; (b) an end of the data segment is reached; and (c) an equivalence class is obtained such that one of the states in the class is a start state of the DFA and another state is a final accepting state.

4. The method of claim 3, wherein if condition (c) exists then the method comprises labeling the flow as a match of the regular expression.

5. The method of claim 1, wherein successor processing comprises:
if a successor is found in the list of equivalent classes for the data segment, merging the predecessor and the successor into one partial flow.

6. The method of claim 1, further comprising merging equivalent classes within the list of equivalent classes.

7. The method of claim 1, further comprising, if sequence numbers of the data segments are consecutive, merging equivalence classes of data segments.

8. The method of claim 7, wherein merging the predecessor and the successor into one partial flow further comprises:
updating the starting offset of the successor to equal the starting offset of the predecessor;
merging the predecessor equivalent class list with the successor equivalent class list and deleting the predecessor object from the equivalent class list.

9. The method of claim 1, wherein as the DFA is traversed, the number of equivalence classes in the list diminishes.

10. The method of claim 9, wherein when the number of equivalent classes reaches a threshold, then the method comprises:
applying a sequential algorithm to the diminished number of equivalence classes.

11. A method for regular expression matching over a plurality of packets, wherein the regular expression is converted into a deterministic finite state automation DFA), the method comprising:
1) for any out of order data segment, running a first version of a regular expression matching algorithm for a first number of steps;
2) running a second version of the regular expression matching algorithm; and
3) determining whether the flow matches the regular expression.

12. The method of claim 9, further comprising:
running the second version of the regular expression matching algorithm on remaining characters of the data segment starting from every equivalent class' ending state.

13. The method of claim 9, wherein the first version of the algorithm is associated with processing a plurality of equivalence classes and the second version of the algorithm is a sequential version.

14. The method of claim 11, wherein the first version of the algorithm stores equivalent classes associated with automaton pairs having different starting states and identical ending states and the sequential version stores state pairs.

15. The method of claim 9, wherein a result of running the second version of the algorithm is a listing of state pairs.

16. A computer-readable medium storing instructions for controlling a computing device to perform the steps:
a) traversing the DFA using the data segment and a list of all non-accepting states; and
b) if the plurality of packets is not declared as matching, then storing, as list of equivalence classes, automaton state pairs having different starting states but an identical ending state; and
2) determining whether the flow matches the regular expression.

17. The computer-readable medium of claim 16, wherein step 1) occurs for a dta segment that arrives out of order.

18. A computing device that performs regular expression matching over a plurliaty of packets, the computing device comprising:
1) a module configured to, for each data segment in a flow with no predecessor in a stored list of objects generated from traversing a deterministic finite sate automation (DFA) associated with the regular expression:
a) traversing the DFA using the data segment and a list of all non-accepting states; and
b) if the plurality of packets is not declared as matching, then storing, as list of equivalence classes, automaton state pairs having different starting states but an identical ending state; and
2) a module configured to determine whether the flow matches the regular expression.

19. The computing device of claim 18, wherein the steps of traversing the DFA and storing the automation state pairs occur for a data segment that arrives out of order.
